(19) United States
(12) Patent Application Publication
(10) Pub. No.: US 2024/0109545 A1
(43) Pub. Date: Apr. 4, 2024

(54) VEHICULAR CONTROL SYSTEM UTILIZING CAMERAS FOR VISION-BASED NAVIGATION OF THE VEHICLE

(71) Applicant: Magna Electronics Inc., Auburn Hills, MI (US)

(72) Inventor: Christopher Ming Wei, Stoughton, MA (US)

(21) Appl. No.: 18/472,279

(22) Filed: Sep. 22, 2023

Related U.S. Application Data
(60) Provisional application No. 63/377,108, filed on Sep. 26, 2022.

(51) Int. Cl. B60W 40/10; G06T 7/246

(52) U.S. Cl. CPC B60W 40/10; G06T 7/246; B60W 60/001; B60W 2420/42; B60W 2520/10; B60W 2540/18; B60W 2540/20; B60W 2556/50; B60W 2710/20; B60W 2720/106

(57) ABSTRACT

A vehicular driving assist system includes a camera disposed at a vehicle and capturing frames of image data. An electronic control unit (ECU) includes an image processor for processing frames of image data captured by the camera. The system, responsive to processing at the ECU of frames of image data captured by the camera, detects a plurality of features, each feature representative of at least a portion of an object viewed by the camera. The system predicts a trajectory of the vehicle and selects a subset of the plurality of features based on the predicted trajectory of the vehicle. The system (i) tracks the subset of the plurality of features in subsequent frames of image data captured by the camera and (ii) does not track features outside the subset of the plurality of features in subsequent frames of image data captured by the camera.

### CROSS REFERENCE TO RELATED APPLICATION

The present application claims the filing benefits of U.S. provisional application Ser. No. 63/377,108, filed Sep. 26, 2022, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

A vehicular driving assist system includes a camera disposed at a vehicle equipped with the vehicular driving assist system that views exterior of the vehicle. The camera captures frames of image data. The camera includes a CMOS imaging that includes at least one million photosensors arranged in rows and columns. The system includes an electronic control unit (ECU) with electronic circuitry and associated software. Frames of image data captured by the camera are transferred to and are processed at the ECU. The vehicular driving assist system, responsive to processing at the ECU of frames of image data captured by the camera and transferred to the ECU, detects a plurality of features. Each feature is representative of at least a portion of an object imaged by the camera. The vehicular driving assist system predicts a trajectory of the vehicle, and the vehicular driving assist system selects a subset of the plurality of features based on the predicted trajectory of the vehicle. The vehicular driving assist system (i) tracks the subset of the plurality of features in subsequent frames of image data captured by the camera and (ii) does not track features outside the subset of the plurality of features in subsequent frames of image data captured by the camera.

These and other objects, advantages, purposes and features of the present invention will become apparent upon review of the following specification in conjunction with the drawings.

### BRIEF DESCRIPTION OF THE DRAWINGS

FIG. 1 is a perspective view of a vehicle with a vision system that incorporates one or more cameras;

FIG. 2 is an image captured by the vision system of FIG. 1 that includes detected features;

FIG. 3 is a block diagram of a conventional perception pipeline for a vision system;

FIG. 4 is a block diagram of a perception pipeline for the vision system of FIG. 1;

FIG. 5 is a schematic view of a coordinate system for a vehicle;

FIG. 6 is an image captured by the vision system of FIG. 1 that includes a trailing region and a leading region;

FIG. 7 is an image captured by the vision system of FIG. 1 that includes an optimal region; and

FIG. 8 are two images captured by the vision system of FIG. 1 with the vehicle moving at different speeds.

### DESCRIPTION OF THE PREFERRED EMBODIMENTS

A vehicle vision system and/or driver or driving assist system and/or object detection system and/or alert system operates to capture images exterior of the vehicle and may process the captured frames of image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like.

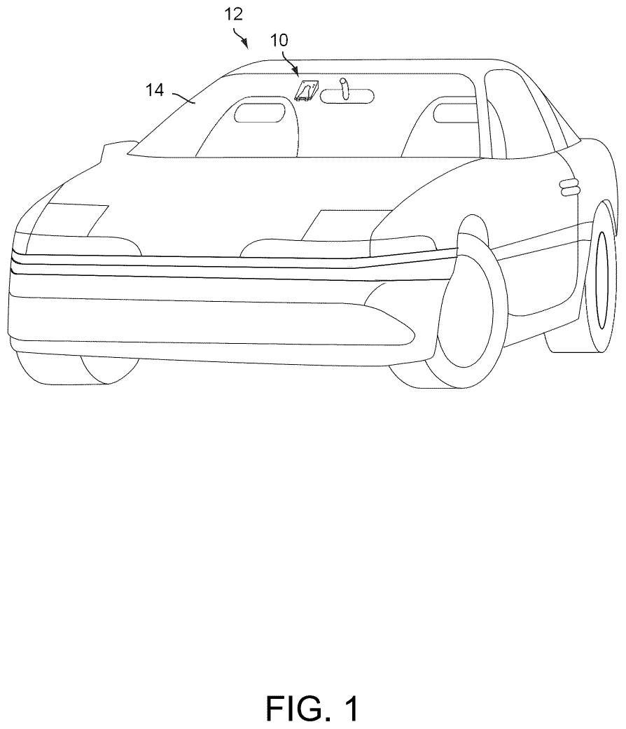

Referring now to the drawings and the illustrative embodiments depicted therein, a vision system 10 for a vehicle 12 includes at least one exterior viewing imaging sensor or camera, such as a forward viewing imaging sensor or camera, which may be disposed at and behind the windshield 14 of the vehicle and viewing forward through the windshield so as to capture image data representative of the scene occurring forward of the vehicle (FIG. 1). Optionally, the system may include multiple exterior viewing imaging sensors or cameras, such as a forward viewing camera at the front of the vehicle, and a sideward/rearward viewing camera at respective sides of the vehicle, and a rearward viewing camera at the rear of the vehicle, which capture images exterior of the vehicle. The camera or cameras each include a lens for focusing images at or onto an imaging array or imaging plane or imager of the camera. The forward viewing camera disposed at the windshield of the vehicle views through the windshield and forward of the vehicle, such as for a machine vision system (such as for traffic sign recognition, headlamp control, pedestrian detection, collision avoidance, lane marker detection and/or the like). The vision system 10 includes a control or electronic control unit (ECU) having electronic circuitry and associated software, with the electronic circuitry including a data processor or image processor that is operable to process image data captured by the camera or cameras, whereby the ECU may detect or determine presence of objects or the like and/or the system provide displayed images at a display device for viewing by the driver of the vehicle. The data transfer or signal communication from the camera to the ECU may comprise any suitable data or communication link, such as a vehicle network bus or the like of the equipped vehicle.

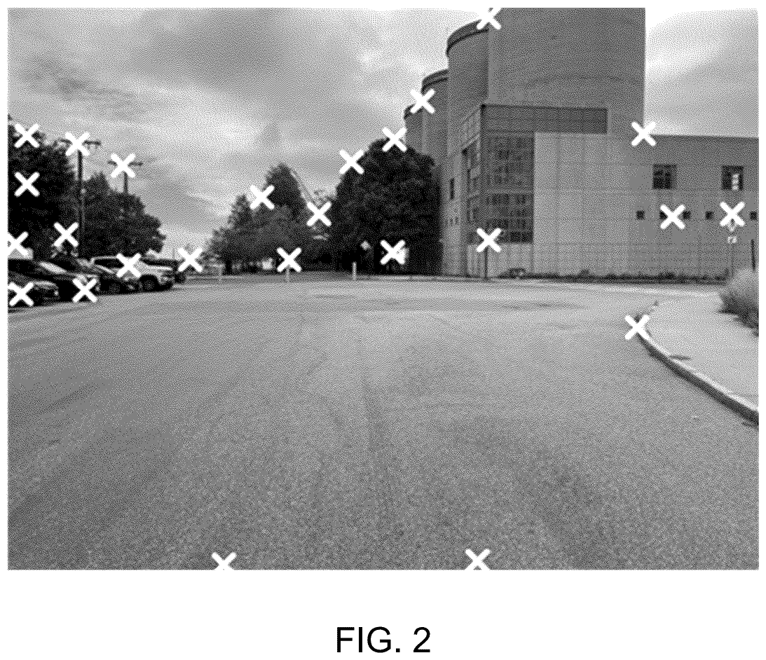

Vision-based or visual navigation is a process by which a partially or fully autonomous vehicle estimates motion through the environment using one or more image sensors such as cameras as the sole input to the navigation/perception pipeline. Cameras tend to provide a lower cost solution than other sensors (e.g., lidar, radar, etc.) and collect information similar to the human eye. By tracking computer vision image features, such as corners or edges of detected objects, from frame to frame, a vehicular vision system can determine an estimate of vehicle motion relative to the environment. For example, as shown in FIG. 2, the system may use a Harris corner detector to extract corners and infer features from captured images. In this example, each “X” refers to a detected corner. As used herein, a corner refers to a point whose local neighborhood stands in two different edge directions (i.e., a junction of two different edges). An edge is generally represented as a sudden change in image brightness. The Harris corner detector takes into account the differential of corner scores with reference to direction directly, however, other corner detectors may also be used.

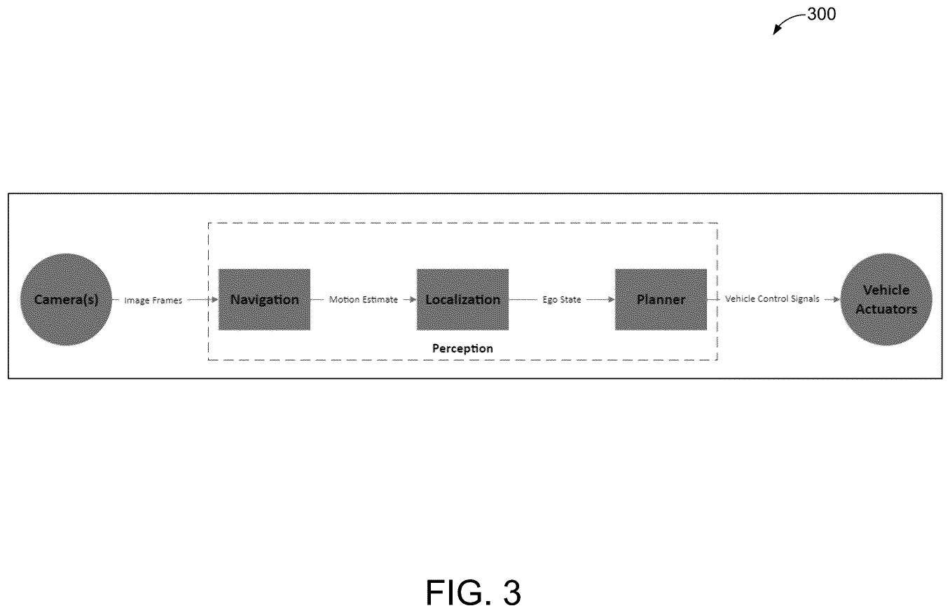

Cameras also provide a way to visually classify objects around the vehicle. As shown in an exemplary block diagram 300 of FIG. 3, a motion estimate (e.g., from the Harris corner detector derived from captured image data or any other motion estimator), also known as odometry (i.e., the use of motion data to estimate a change in position over time), is fed as an input to a localization block or module. The localization block provides a vehicle state estimate to a planner block. The planner block plans and prescribes the movement of the vehicle (i.e., the speed, acceleration, and/or trajectory/direction of the vehicle).

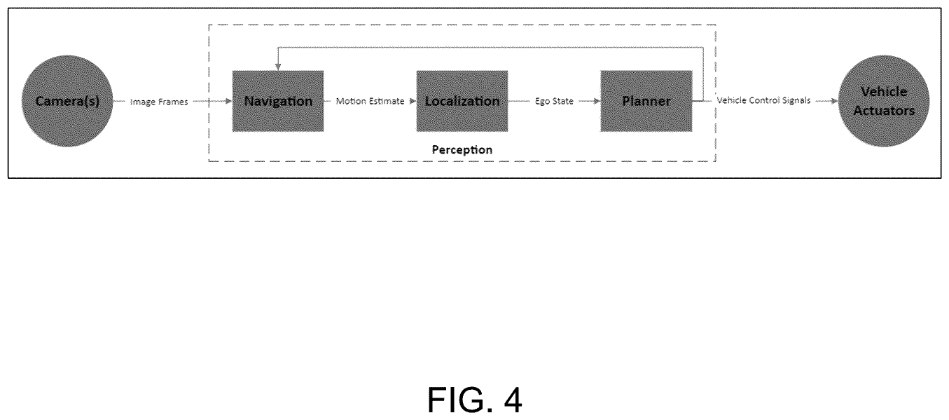

Implementations herein provide a system applicable to situations where vehicles using visual navigation (e.g., via one or more cameras or the like) are moving in trajectories other than the scenario where the vehicle is moving in a straight line at a constant speed. That is, the system is applicable when the vehicle is following a non-straight trajectory and/or is moving at a non-constant speed. While conventional systems generally include a perception pipeline that is a mono-directional process (FIG. 3), the vehicular vision system 10 includes a feedback loop (FIG. 4) from the planner to the navigation block for creation of an additional level of self-awareness in the vehicle that conventional systems lack, as illustrated in the block diagram 400. The awareness allows the navigation pipeline to prioritize incoming information and use allocated computational resources more efficiently.

During the navigation process (i.e., controlling lateral and/or longitudinal movement of the vehicle autonomously or semi-autonomously), the system looks for visual features (e.g., corners or edges) in a frame of image data captured by one or more cameras. When the system identifies a set of features from the frame of image data, the system creates a track or trail for each feature in order to follow that feature's position in subsequent frames of captured image data. The system may require at least a threshold number of visual features be tracked prior to generating an odometry/motion estimate (e.g., an estimate of a current position relative to a previous or initial position). While using less than the threshold number of features may allow for faster estimates, the results may be unacceptably inaccurate. Failure to produce accurate estimates can lead to partial or total failure of the pipeline. Optionally, the threshold number of features is configurable or adjustable by the user or by the system based on various vehicle parameters (e.g., size, speed, weight, etc.) and/or environmental factors (e.g., weather, time, traffic, etc.).

The system may track a number of features greater than the threshold amount to yield a better odometry estimate, however each additional tracked feature comes at the cost of increased processing time. Thus, tracking too many features may result in a poor odometry estimate due to the inter-frame latency introduced by the increased processing time required by the large number of features. The optimal number of tracked features is an amount that allows for an acceptably accurate odometry estimate while not creating an unacceptable amount of latency in the pipeline. To this end, the system includes an attentiveness algorithm that optimizes the feature set without increasing the pipeline's computational resource requirement or introducing any additional latency. The algorithm accomplishes this by only creating new feature tracks in a region of interest (ROI) of the camera frame deemed advantageous by the algorithm based on the knowledge of the planned future path of the vehicle.

The vehicular vision system may include a single camera or multiple cameras, different camera types, and/or cameras with various different vision-based feature detectors as inputs. The attentiveness algorithm may assume that the perception pipeline of the system has navigation, localization, and path planning modules.

The attentiveness algorithm mimics the way a human looks further down the road as they drive faster and to the right or left as when a human prepares to make a turn. The output of the attentiveness algorithm is an adjusted ROI origin and adjusted ROI dimensions for the navigation module.

The foundation of the attentiveness algorithm is that the perception system “pays attention” to where the vehicle will be going in the near future (i.e., the predicted or planned path of the vehicle). This knowledge of future trajectory allows the attentiveness algorithm to adjust focus within the image frame. The intent prediction is provided by creating a feedback loop from the path planner output to the navigation input. The feedback loop provides the future steering angle given by:

θ_{N},−90°≤θ≤90° (1)

The feedback loop also provide the future pitch angle given by:

φ_{N},−90°≤φ≤90° (2)

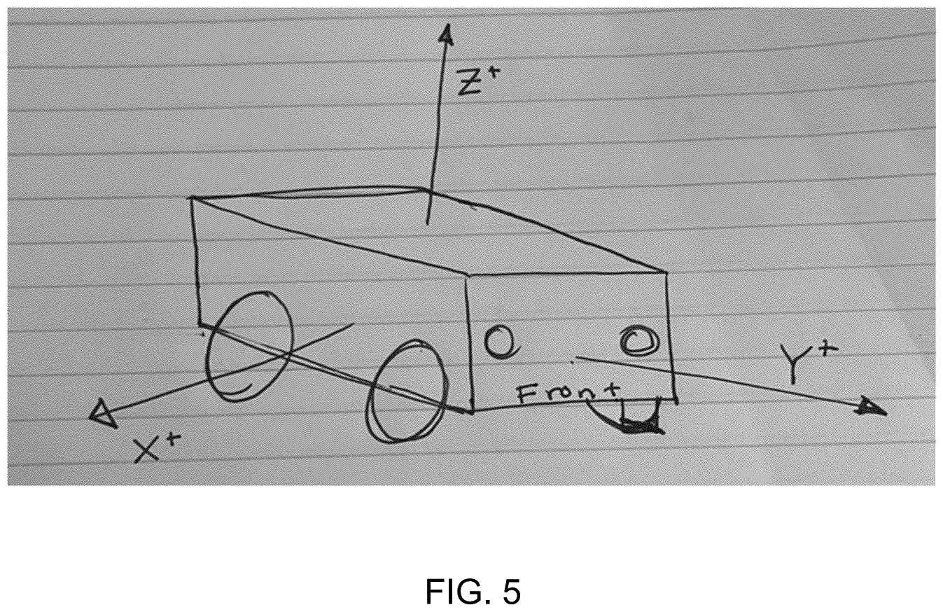

Here, N is the predetermined future time-step, the future vehicle speed is given as absolute vehicle speed, s_{N}, and the system/vehicle coordinate plane is defined as illustrated in FIG. 5 (i.e., with the X axis parallel with the transverse axis of the vehicle, the Y axis parallel with the longitudinal axis of the vehicle, and the Z axis perpendicular to the ground).

The attentiveness algorithm prunes the full image frame into a sub-frame that the system uses to create visual feature tracks or trails which the system in turn uses for navigation estimate calculations. This pruning ensures that only features that are more likely to have longer track lives will be selected. A speed-compensated height, H′_{R}, and width, W′_{R}, of the feature ROI may be defined by:

H′_{R}=H_{F}×(s_{N}×ƒₛ),W′_{R}=W_{F}×(s_{N}×ƒ_{S}) (3)

Here, ƒₛ is the user-defined (i.e., configurable by the user) speed factor, 0 <ƒₛ≤1, and H_{F} and W_{F} are the full height and width of the original image frame, respectively. An orientation adjusted origin is completed with two parts simultaneously. The default origin may be defined as:

O_{R}=(.5W_{F},.5H_{F}) (4)

The updated or adjusted origin may be defined by:

$${{O}^{′}}_{R} = ( \text{.5} {W}_{F} ( 1 + \frac{{θ}_{N}}{360} \times {f}_{h} ) , \text{.5} {H}_{F} ( 1 + \frac{{ϕ}_{N}}{360} \times {f}_{v} ) ) \qquad ( 5 )$$

Here, ƒₕ and ƒᵥ are user-defined scaling factors 0 <ƒₕ, ƒᵥ≤1.

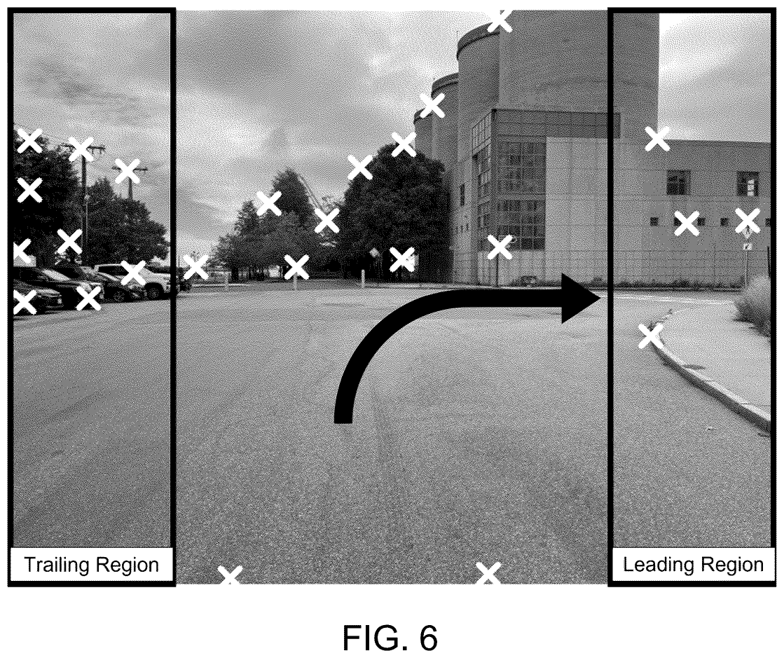

FIG. 6 illustrates a scenario where a vehicle is preparing to make a right-hand turn. That is, the planner block has planned for the vehicle to turn right (e.g., to follow a route to reach the vehicle's destination). The planner block may determine or predict or estimate the future trajectory (i.e., the turn) in any number of ways. For example, the planner block may use a turn signal indicator, an angle of the wheels, a deceleration of the vehicle, a navigation system output from a navigation or GPS system, analysis of image data (e.g., by tracking a trajectory of the current lane the vehicle is traveling along), etc., to determine the upcoming trajectory. Here, a simple Harris corner detector identifies visual features in the frame of image data, with each detected corner represented by an ‘X.’ In this example, the detected corners are the features that the system tracks across frames. Without any compensated ROI, the visual navigation processor (e.g., a control or ECU) of the vehicle may use all visual features found in the image frame (i.e., each ‘X’ in FIG. 6). As the vehicle maneuvers through the planned path by turning right (illustrated in this example as an arrow), features will disappear off the left edge of the frame of image data as the field of view of the camera swings with the vehicle through the right turn. Features in the box labeled “Trailing Region” will have the shortest remaining life (i.e., will be present in the field of view of the camera for the least amount of time), as these will be the first features to fall out of the field of view of the camera as the vehicle begins the turn. Because of the short remaining life of these features, it is not efficient or effective to spawn new tracks tracking those particular features. However, features in the box labeled “Leading Region” will have the longest potential remaining life, and thus these features represent a high value area to initiate new tracks. Meanwhile, the features in the center of the frame fall between the trailing region and the leading region in effectiveness. Note that this image and path are purely exemplary. If instead the vehicle was turning to the left, the trailing region may be located at the right of the frame and the leading region may be located at the left of the frame. If the vehicle is not turning and instead continuing straight, the leading region may include the center of the image frame and the trailing region may be the outer edges of the frame.

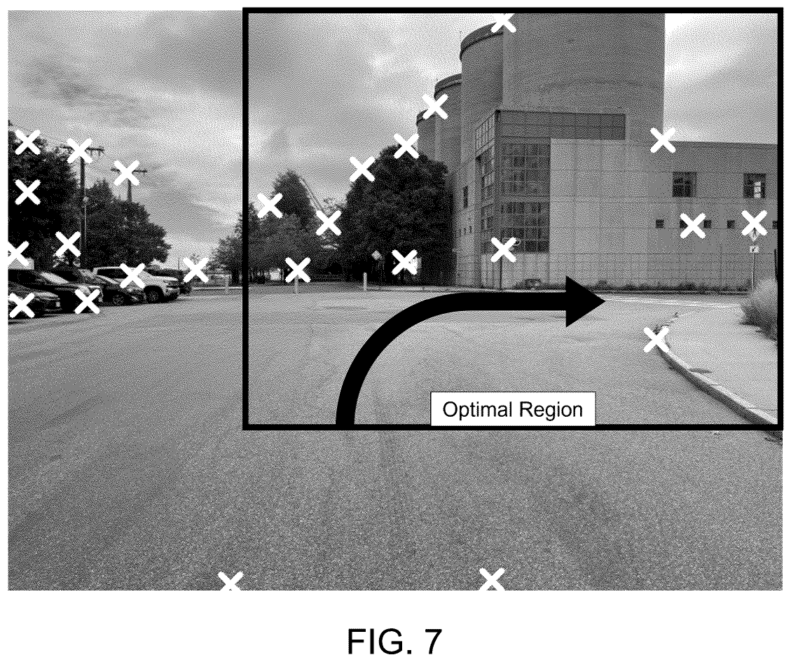

Referring now to FIG. 7, the example from FIG. 6 is continued with a box labeled “Optimal Region” that represents the ROI which has compensated for the immediately planned maneuver (i.e., the upcoming right turn). This allows the system to ignore or disregard a portion of the features (e.g., detected corners). In this example, the system may ignore 12 of the 25 visual features in the total image field (i.e., the 12 features that are outside of the optimal region). This decreases the computational resources required to track the features and decreases latency when tracking the features. In some examples, the algorithm could be used to define the region for the system to look for additional features within the optimal region to use for navigation (e.g., to meet the minimum threshold required to generate the estimate). In some examples, when an insufficient number of features are present within the optimal region (e.g., to meet the minimum threshold), the system may expand the optimal region and/or add one or more features nearest to the optimal region. For example, when the threshold number of features is 20, and an initial optimal region only includes 15 features, the system may expand a size of the optimal region until the optimal region includes at least 20 features. The system may expand the size of the optimal region in both directions (i.e., the x axis and the y axis) equally or may favor one direction over the other based on various parameters, such as the predicted trajectory of the vehicle, distribution and density of detected features, state of the vehicle, etc.

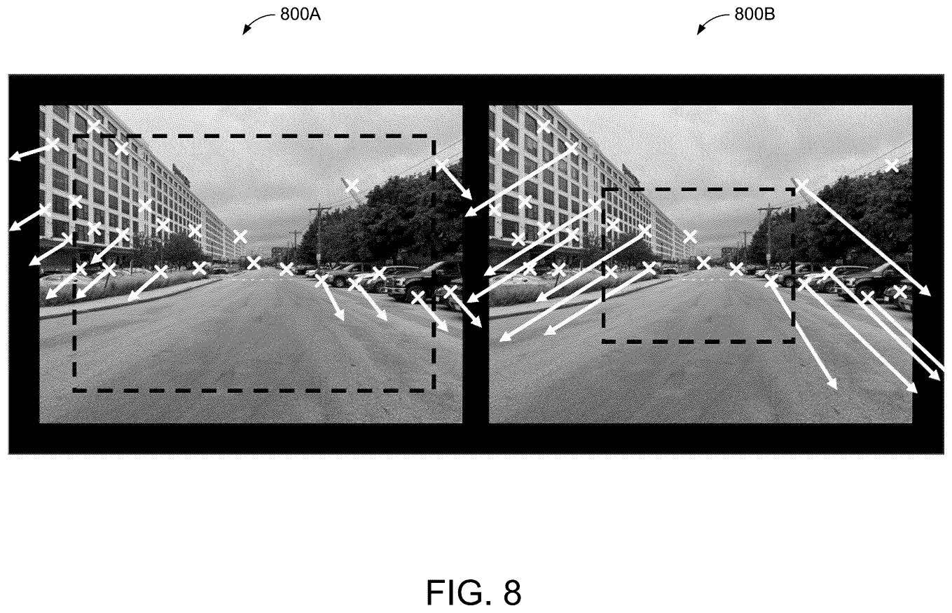

Referring now to FIG. 8, in this example scenario, the vehicle is traveling along a straight road at two different speeds. Again, the visual features in this example are each marked by an ‘x’ and generated by, for example, a corner detector. Here, each feature is associated with an arrow of varying length. The arrow length is representative of how far the feature will move through the frame over the desired lifetime of a track. In the image 800A, the equipped vehicle that is equipped with the camera that captured the image 800A is moving at a slower velocity than the equipped vehicle that is equipped with the camera that captured the image 800B. Thus, in image 800A, only features at the edge of the frame will disappear (represented as the arrow extending beyond the edge of the image data) before the end of their desired lifetime. In contrast, in the image 800B, the faster vehicle speed causes the features to move through the frame more rapidly (as the field of view of the camera changes more rapidly), and thus more features (relative to image 800A) will disappear. In order to compensate for the velocity of the vehicle and to ensure acceptable track life for each feature, the region where new tracks originate (i.e., the optimal region as illustrated here by the dashed box) may be more tightly focused on the center of the frame the greater the velocity of the vehicle. That is, optionally, the ROI is based on the predicted trajectory of the vehicle and/or the velocity/acceleration of the vehicle.

For autonomous vehicles suitable for deployment with the system, an occupant of the vehicle may, under particular circumstances, be desired or required to take over operation/control of the vehicle and drive the vehicle so as to avoid potential hazard for as long as the autonomous system relinquishes such control or driving. Such an occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Thus, implementations herein include a vehicular vision system or sensing system or driving assist system that includes a camera that captures frames of image data. The system, responsive to processing a frame of image data captured by the camera, detects a plurality of features in the frame. The system predicts or determines a trajectory of the vehicle (i.e., a path the vehicle will follow as the vehicle travels along). Based on the predicted trajectory, the system selects a subset of the features in the frame of image data, and tracks only the subset of features (i.e., does not track the remaining features) to reduce the required computational resources. The system, using the subset of features, estimates motion of the vehicle. Thus, the system estimates motion of the vehicle by tracking only a subset of the detected features (based on, for example, a predicted trajectory of the vehicle, a current or predicted speed of the vehicle, etc.). This allows the system to limit the computational requirements of tracking the features.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or pixels arranged in rows and columns. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a camera disposed at a vehicle equipped with the vehicular driving assist system and viewing exterior of the vehicle, the camera capturing frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular driving assist system, responsive to processing at the ECU of frames of image data captured by the camera and transferred to the ECU, detects a plurality of features, each feature representative of at least a portion of an object imaged by the camera;
wherein the vehicular driving assist system predicts a trajectory of the vehicle;
wherein the vehicular driving assist system selects a subset of the plurality of features based on the predicted trajectory of the vehicle; and
wherein the vehicular driving assist system (i) tracks the subset of the plurality of features in subsequent frames of image data captured by the camera and (ii) does not track features outside the subset of the plurality of features in subsequent frames of image data captured by the camera.

2. The vehicular driving assist system of claim 1, wherein the vehicular driving assist system, responsive to tracking the subset of the plurality of features, controls steering of the vehicle.

3. The vehicular driving assist system of claim 1, wherein the vehicular driving assist system, responsive to tracking the subset of the plurality of features, estimates motion of the vehicle, and wherein the vehicular driving assist system controls steering of the vehicle using the estimated motion of the vehicle.

4. The vehicular driving assist system of claim 3, wherein the estimated motion comprises an estimate of a current position of the vehicle relative to an initial position of the vehicle.

5. The vehicular driving assist system of claim 1, wherein the plurality of features comprises at least one selected from the group consisting of (i) an edge of an object and (ii) a corner of an object.

6. The vehicular driving assist system of claim 1, wherein the vehicular driving assist system uses a corner detector to detect the plurality of features.

7. The vehicular driving assist system of claim 6, wherein the corner detector comprises a Harris corner detector.

8. The vehicular driving assist system of claim 1, wherein the vehicular driving assist system determines a region of interest within the frame of image data based on the predicted trajectory of the vehicle, and wherein the vehicular driving assist system selects the subset of the plurality of features from the features present within the region of interest.

9. The vehicular driving assist system of claim 8, wherein the region of interest represents a portion of the frame of image data where features have a likelihood of remaining within the view of the camera for longer than features not within the region of interest based on the predicted trajectory of the vehicle.

10. The vehicular driving assist system of claim 8, wherein the vehicular driving assist system determines a size of the region of interest based at least in part on a minimum threshold number of features value.

11. The vehicular driving assist system of claim 10, wherein the region of interest encompasses a number of features of the plurality of features that at least meets the minimum threshold number of features value.

12. The vehicular driving assist system of claim 10, wherein the vehicular driving assist system increases the size of the region of interest when a number of features of the plurality of features within the region of interest fails to exceed the minimum threshold number of features value.

13. The vehicular driving assist system of claim 8, wherein the vehicular driving assist system determines a size of the region of interest based at least in part on a velocity of the vehicle.

14. The vehicular driving assist system of claim 13, wherein the size of the region of interest decreases as the velocity of the vehicle increases.

15. The vehicular driving assist system of claim 1, wherein the vehicular driving assist system predicts the trajectory of the vehicle at least in part based on the frame of image data.

16. The vehicular driving assist system of claim 1, wherein the vehicular driving assist system predicts the trajectory of the vehicle at least in part based on at least one selected from the group consisting of (i) a turn signal of the vehicle, (ii) a steering angle of the vehicle, and (iii) a navigation output from a navigation system of the vehicle.

17. A vehicular driving assist system, the vehicular driving assist system comprising:
a camera disposed at a vehicle equipped with the vehicular driving assist system and viewing exterior of the vehicle, the camera capturing frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular driving assist system, responsive to processing at the ECU of frames of image data captured by the camera and transferred to the ECU, detects a plurality of features, each feature representative of at least a portion of an object imaged by the camera;
wherein the vehicular driving assist system predicts a trajectory of the vehicle;
wherein the vehicular driving assist system selects a subset of the plurality of features based on the predicted trajectory of the vehicle;
wherein the vehicular driving assist system (i) tracks the subset of the plurality of features in subsequent frames of image data captured by the camera and (ii) does not track features outside the subset of the plurality of features in subsequent frames of image data captured by the camera;
wherein the vehicular driving assist system, responsive to tracking the subset of the plurality of features, estimates motion of the vehicle; and
controlling, using the estimated motion of the vehicle, (i) steering of the vehicle and (ii) acceleration of the vehicle.

18. The vehicular driving assist system of claim 17, wherein the plurality of features comprises at least one selected from the group consisting of (i) an edge of an object and (ii) a corner of an object.

19. The vehicular driving assist system of claim 17, wherein the vehicular driving assist system uses a corner detector to detect the plurality of features.

20. The vehicular driving assist system of claim 19, wherein the corner detector comprises a Harris corner detector.

21. A vehicular driving assist system, the vehicular driving assist system comprising:
a camera disposed at a vehicle equipped with the vehicular driving assist system and viewing exterior of the vehicle, the camera capturing frames of image data;
wherein the camera comprises a CMOS imaging array, and wherein the CMOS imaging array comprises at least one million photosensors arranged in rows and columns;
an electronic control unit (ECU) comprising electronic circuitry and associated software;
wherein frames of image data captured by the camera are transferred to and are processed at the ECU;
wherein the vehicular driving assist system, responsive to processing at the ECU of frames of image data captured by the camera and transferred to the ECU, detects a plurality of features, each feature representative of at least a portion of an object imaged by the camera;
wherein the vehicular driving assist system uses a corner detector to detect the plurality of features;
wherein the vehicular driving assist system predicts a trajectory of the vehicle;
wherein the vehicular driving assist system determines a region of interest within the frame of image data based on the predicted trajectory of the vehicle;
wherein the vehicular driving assist system selects a subset of the plurality of features from the features present within the region of interest; and
wherein the vehicular driving assist system (i) tracks the subset of the plurality of features in subsequent frames of image data captured by the camera and (ii) does not track features outside the subset of the plurality of features in subsequent frames of image data captured by the camera.

22. The vehicular driving assist system of claim 21, wherein the region of interest represents a portion of the frame of image data where features have a likelihood of remaining within the view of the camera for longer than features not within the region of interest based on the predicted trajectory of the vehicle.

23. The vehicular driving assist system of claim 21, wherein the vehicular driving assist system determines a size of the region of interest based at least in part on a minimum threshold number of features value.

24. The vehicular driving assist system of claim 23, wherein the region of interest encompasses a number of features of the plurality of features that at least meets the minimum threshold number of features value.
